(19) United States
(12) Patent Application Publication
(10) Pub. No.: US 2002/0117975 A1
(43) Pub. Date: Aug. 29, 2002

(54) Light emitting variable resistance linear limit voltage circuit system

(76) Inventor: Tai-Her Yang, Si-Hu Town (TW)

Correspondence Address: BACON & THOMAS, 4th Floor, 625 Slaters Lane, Alexandria, VA, 22314, US

(21) Appl. No.: 09/791,825

(22) Filed: Feb. 26, 2001

(51) Int. Cl. H05B 37/02

(52) U.S. Cl. 315/291

(57) ABSTRACT

A light emitting variable resistance linear limit voltage circuit system for comprehensive applications by various types of circuit, particularly when combined with a (dis) chargeable cell for ensuring fully saturated charging by the (dis)chargeable cell, prevent the (dis)chargeable cell from being damaged by overcharging, reduce thermal loss for the limit voltage circuit and provide light emitting display as required.

### BACKGROUND OF THE INVENTION

(a) Field of the Invention

The present invention relates to a circuit system, and more particularly to one provides a light emitting variable resistance linear limit voltage circuit that also matches with rated saturation voltage VS of various cells.

(b) Description of the Prior Art:

In U.S. Pat. No. 5,118,993 and Europe Patent No. 0487204, both granted to the applicant of the present invention, a multi-voltage output circuit comprised of a positive voltage drop from a diode or a zener voltage from a zener diode, or a positive voltage drop effect was disclosed. In the circuit, cells are directly connected in parallel at the output of the multi-voltage output circuit during the charging process. Or in a conventional system, the positive voltage drop from the multiple diodes is directly connected in parallel with the cells to provide a limit voltage divided current. In either application, the circuit indicates a regulated voltage V0 when the terminal voltage of the cells accumulates along with the charging current and rises up to such extent close to, and eventually becomes identical with the positive voltage drop value. However, the positive voltage drop of the diode indicates approximately a gradient of 0.7V difference depending on the number of diodes connected in series. It will be very difficult to match the rated saturation voltage VS of the cells by changing the number of diodes connected in series when the positive voltage drop of the diodes connected in parallel is not of the same value as that of the VS. Therefore, diodes are directly connected in parallel with the batters and such connection creates the following defects:

1. In the absence of additional connection in series of a proper limiting current, a charging current IB decreases when a composite regulated voltage V0 is generated by the positive voltage drop of the diode and the terminal voltage of the cells. As a result, the diodes are vulnerable to be burnt out due to the significantly increased current passing through the diodes as illustrated in FIG. 1 of the accompanying drawings of the present invention; and

2. The positive voltage drop value of the diodes is not consistent with the rated saturation voltage VS required by the cells. If the value is lower than VS, the charging current IB passing through the batters gets too small and consequently, slower charging process or insufficient charging current as illustrated in FIG. 2. On the other hand, if the value gets higher than VS, overcharged.

### SUMMARY OF THE INVENTION

The primary purpose of the present invention is to provide a light emitting variable resistance linear limit voltage circuit system for comprehensive circuit applications, particularly in the application when matching a (dis)chargeable cell to ensure of fully saturated charging, protection damage to the cell due to overcharge, reduction of thermal loss from limit voltage circuit, and light emitting display when required.

### BRIEF DESCRIPTION OF THE DRAWINGS

FIG. 1 is a schematic view showing a process of overcharging a cell using a conventional system of diodes directly connected in parallel as a limit voltage.

FIG. 2 is a schematic view showing a process of undercharging a cell using a conventional system of diodes directly connected in parallel as a limit voltage.

FIG. 3 is a schematic view showing a process of charging a cell for indicating ideal charging characteristics using a conventional system of diodes directly connected in parallel as a limit voltage.

FIG. 4 is a schematic view showing a circuit of a single unit of (dis)chargeable cell of the present invention matching an system of a circuit allowing linear limit voltage.

FIG. 5 is a view showing a preferred embodiment of a light emitting variable resistance linear limit voltage system comprised of light emitting diodes connection in series of the present invention.

FIG. 6 is a view showing a preferred embodiment of a light emitting variable resistance linear limit voltage system comprised of light emitting diodes connection in parallel of the present invention.

FIG. 7 is a view showing a preferred embodiment of a light emitting variable resistance linear limit voltage system comprised of light emitting diodes connection in series-parallel of the present invention.

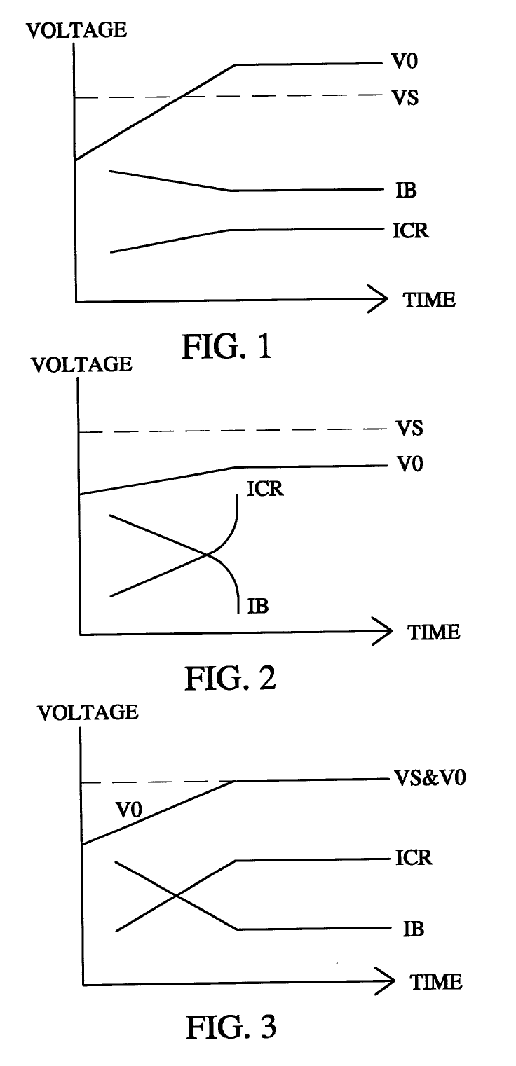

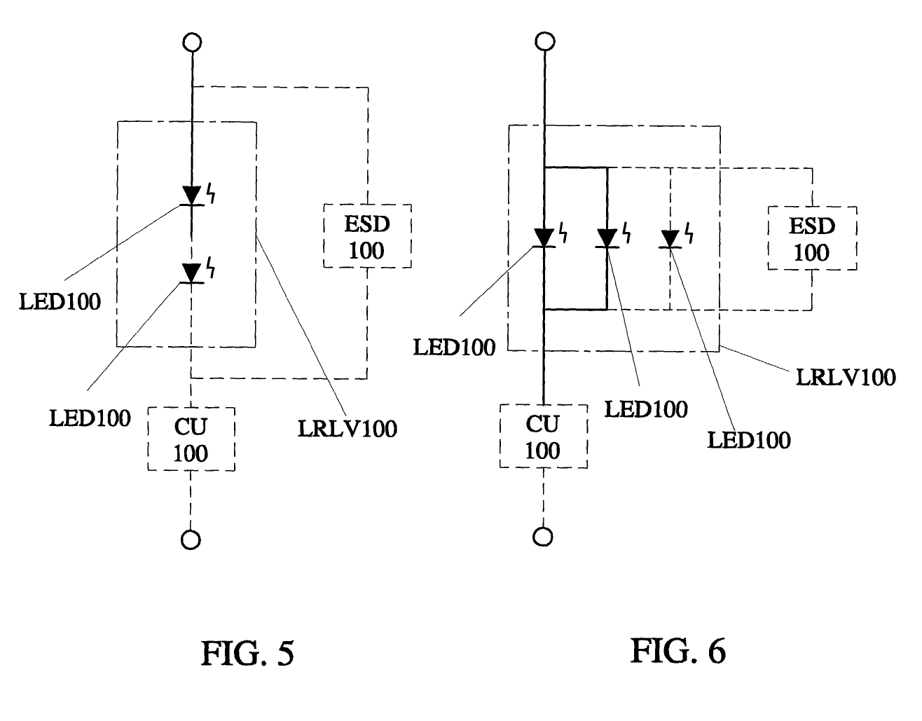

FIG. 5 is a view showing a preferred embodiment of a light emitting variable resistance linear limit voltage system comprised of light emitting diodes connection in series with various types of limit voltage circuit of the present invention.

FIG. 9 is a view showing a preferred embodiment of a light emitting variable resistance linear limit voltage system comprised of light emitting diodes connection in parallel with various types of limit voltage circuit of the present invention.

FIG. 10 is a view showing a preferred embodiment of a light emitting variable resistance linear limit voltage system comprised of light emitting diodes connection in series-parallel with various types of limit voltage circuit of the present invention.

FIG. 11 is a view showing a preferred embodiment of a circuit having additional separation diodes connected in series at an output of the present invention.

FIG. 12 is a schematic view showing multiple units of (dis)chargeable cells connected in series to match multiple units of light emitting variable resistance linear limit voltage circuits connected also in series of the present invention.

FIG. 13 is a view showing an application example of the present invention having the light emitting variable resistance linear limit voltage circuit connected in series with a combination of various types of limit voltage circuits.

FIG. 14 is a view showing another application example of the present invention having the light emitting variable resistance linear limit voltage circuit connected in series with a combination of various types of limit voltage circuits.

FIG. 15 is a view showing a preferred embodiment of a circuit having additional separation diodes connected in series at each output of the present invention.

### DETAILED DESCRIPTION OF THE PREFERRED EMBODIMENTS

To correct defects of the prior art, an impedance Z0 connected in series with diodes may provide more advanced function of allowing linear regulation and match various ratings of saturation voltage VS. When a terminal voltage at the cell rises and becomes greater than a positive voltage drop of a diode (or a zener voltage or positive voltage drop of a zener diode), the current passing through the diode (or the zener diode is further limited by linear regulation. Meanwhile, cells with various ratings of saturated voltage are ensured to achieve saturated charging to protect the diode (or the zener diode) connected in parallel with the cells from being damaged by overcharging. However, the resistance usually will transfer electric energy into thermal energy resulting in overheated circuit. The direct use by the circuit of a light emitting diode as a biased illumination and impedance device which, or the combined use of the light emitting diode and the impedance or replacing the impedance with the light emitting diode, the limit voltage circuit would provide limiting and impedance voltage. Particularly the light emitting diode is able to transfer certain electrical energy that may be otherwise transferred into thermal energy into optical energy, the thermal energy is reduced while the optical energy can be utilized for display purpose.

In a conventional application of having the diode connected in series with both terminals in parallel of the cell to function as a limit voltage branch current, both of the positive voltage drop and the cell terminal combine into a regulated voltage V0 when charged to certain extent. At this time, a charging current IB passing through the diode and cell indicate a branch status. If the combined terminal voltage V0 becomes greater than IB, a branch current ICR passing through the diode significantly increases. That's one of the defectives found with conventional system. If the cell is connected in parallel with one or multiple matching diodes connected in series or an additional zener effect device containing a zener diode is connected in series to serve as an impedance for linear current regulation, a drop is created with the branch current ICR passing through the diode (or the zener effect device). Furthermore, an impedance drop takes place at both terminals of the impedance that varies depending on the variation of the branch current ICR. As illustrated in FIG. 3, the impedance drop and the positive voltage drop passing through the diode (or the zener effect device) become aggregated and subject to lineal regulation by the branch current to charge the cells create a combined regulated voltage with the cells connected in parallel at a value identical to or close to a rated saturation voltage VS of a selected cell. Meanwhile, the current passing through the diode (or the vener effect device) is also subject to linear regulation by the impedance. However, the flaw is that thermal loss occurs once the electrical energy of the impedance device and the diode or the vener device is approaching 100%. Said significant thermal loss does not provide any other positive function and the similar flaw is also found in other circuit applications with all those said devices.

A light emitting variable resistance linear limit voltage circuit system of the present invention will reduce the amount of thermal energy, and have the optical energy to be made available for emitting display as may be required without compromising its exiting linear limit voltage feature. Such reduction is achieved by replacing the diode, the zener diode or the resistance or by mixing one or more than one of said devices with one or multiple light emitting diodes having illuminant and resistant features connected in series, parallel or series-parallel. As a result, electrical energy is transferred into optical and thermal energy. The circuit system of the present invention is applicable to various types of circuits, particularly when adapted to a (dis)chargeable cell system to assure of saturated charging, preventing damage due to overcharging, reducing thermal loss of the limit voltage circuit or providing emitting display when required.

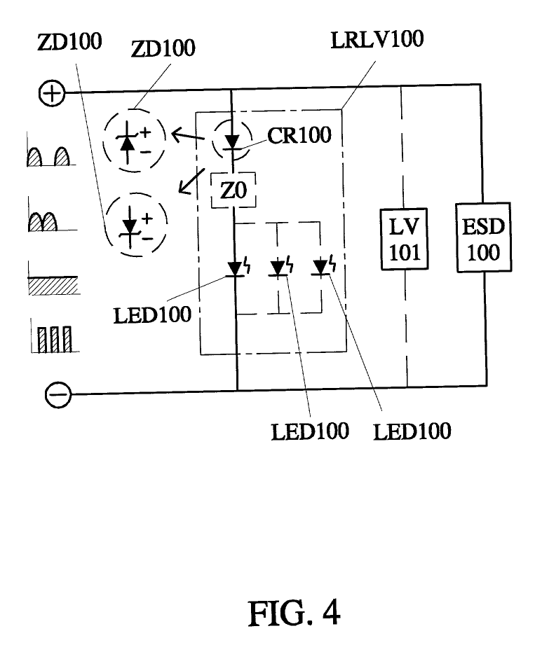

Furthermore, depending on the polarity of the drop created by a unit LRLV100 of the light emitting variable resistance linear limit voltage circuit system of the present invention, the system is connected either in series or parallel to both terminals of a (dis)chargeable cell unit ESD100 to serve as charging protection, or to be connected in series or parallel with a electromechanical or solid status switching system or a linear control system CU100, and to a loading in series or parallel for manipulation. As illustrated in FIG. 4, a circuit of a unit of (dis)chargeable cell system matching a linear limit voltage system of the present invention is essentially comprise of :

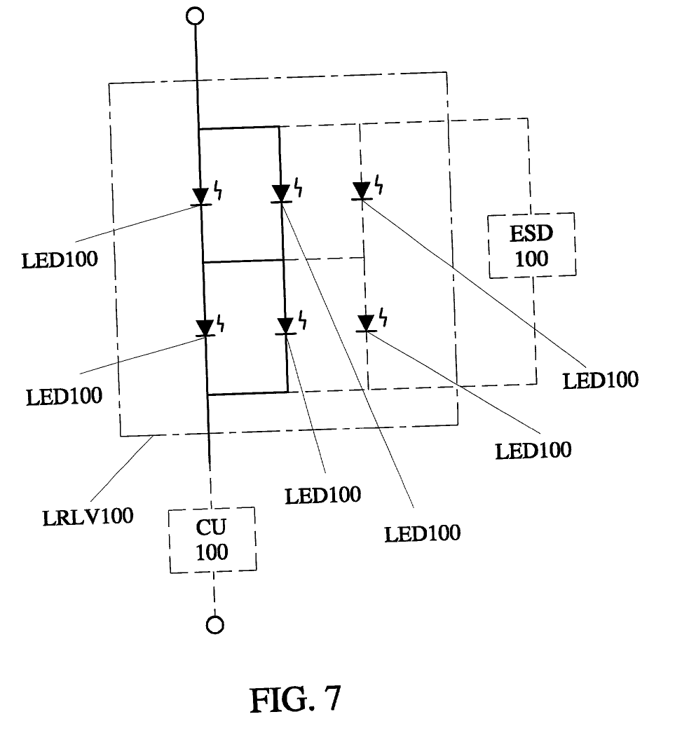

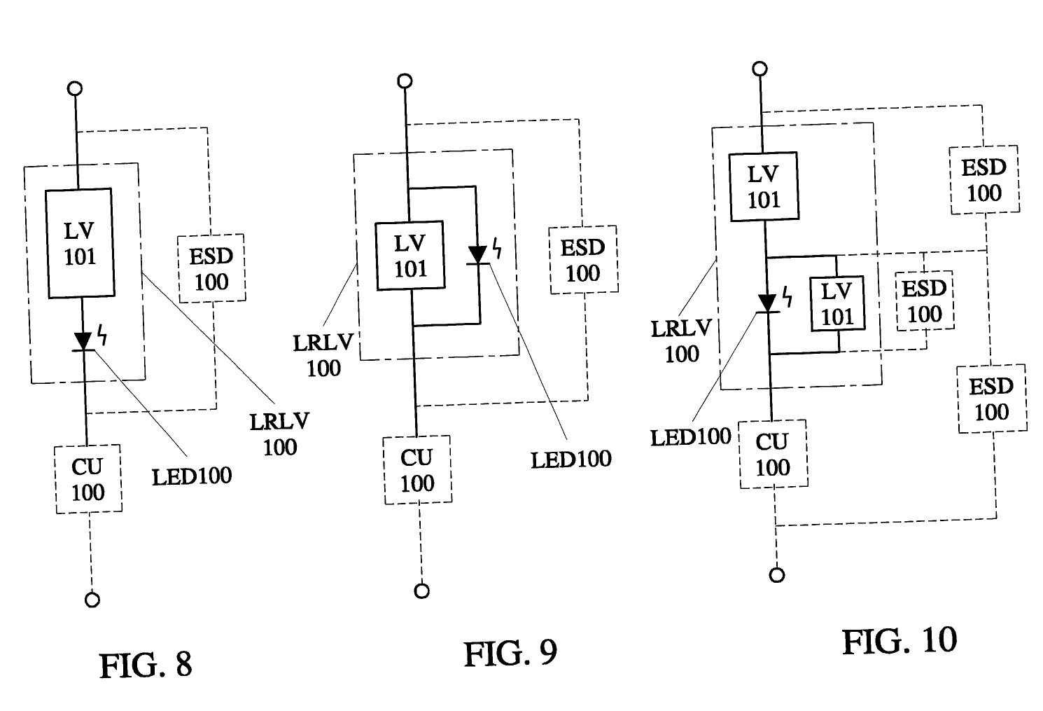

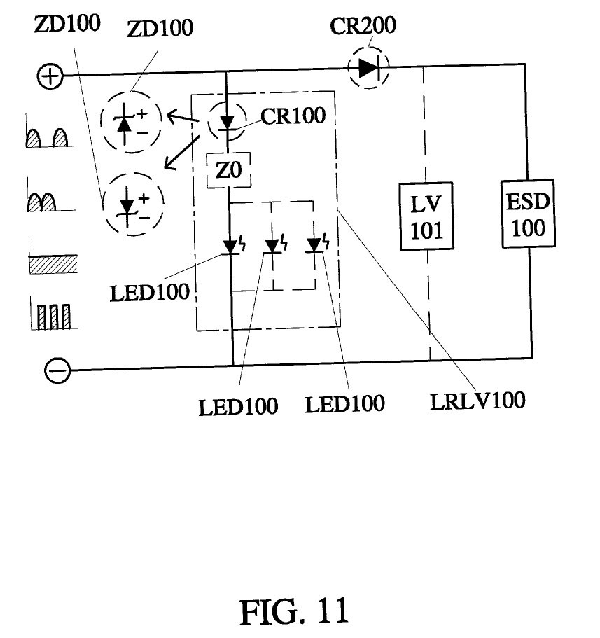

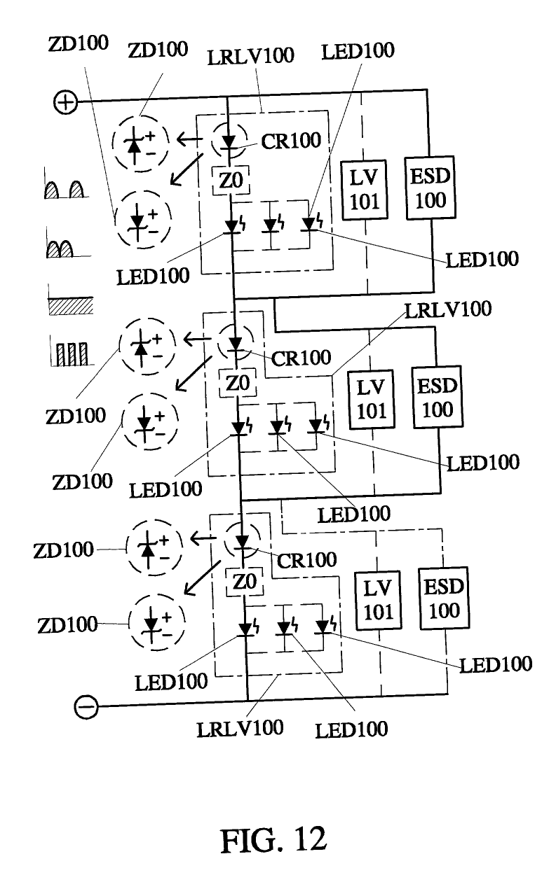

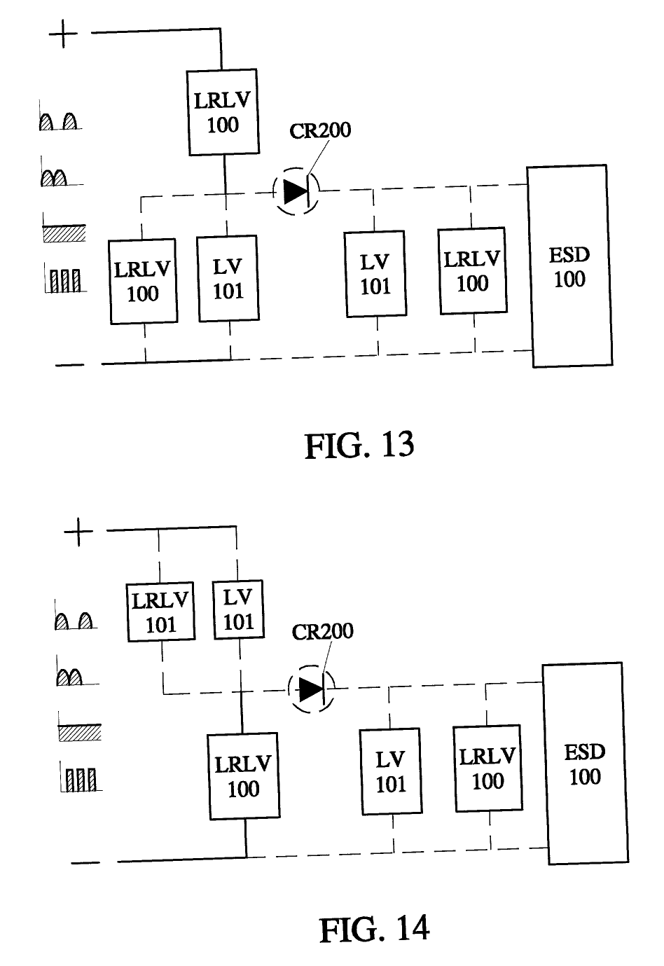

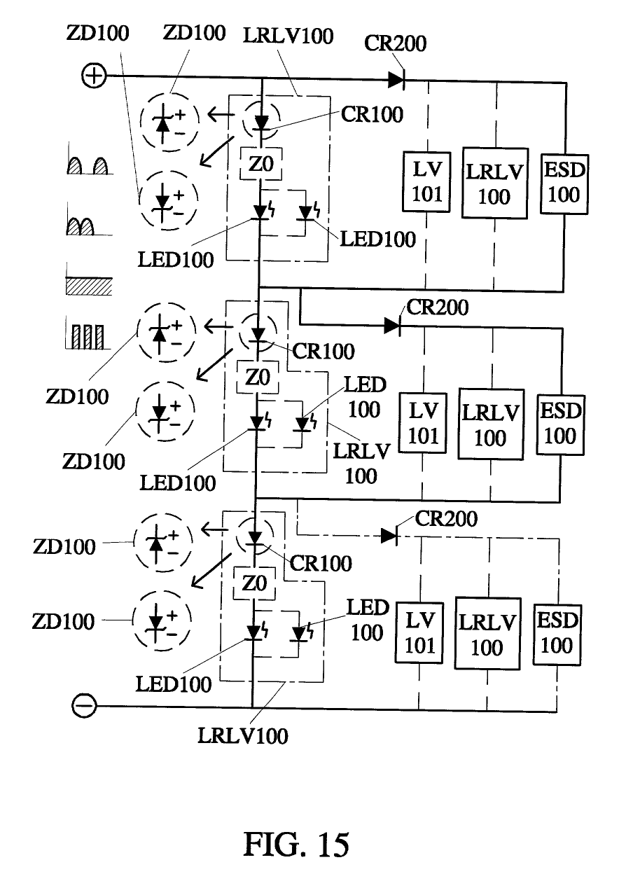

a light emitting variable resistance linear limit voltage circuit system LRLV100: FIG. 5 shows a preferred embodiment of a light emitting variable resistance linear limit voltage circuit system of the present invention comprised of light emitting diodes connected in series. FIG. 6 shows a preferred embodiment of a light emitting variable resistance linear limit voltage circuit system of the present invention comprised of light emitting diodes connected in parallel. FIG. 7 shows a preferred embodiment of a light emitting variable resistance linear limit voltage circuit system comprised of light emitting diodes connected in series-parallel. Within, various types of a limit voltage LV101 are respectively comprised of one or multiple light emitting diodes LED100 connected either in series, parallel or series-parallel; or of at least one type or multiple types of one or multiple diodes CR100, positive or reverse zener diode ZD100 or other zener effect device, and/or impedance device ZO connected in series, parallel or series-parallel. Then the LV101 is connected in series, parallel, or series-parallel with one or multiple light emitting diodes LED100 connected in series, parallel or series-parallel to combine the LRLV100. FIG. 8 shows a preferred embodiment of a light emitting variable resistance linear limit voltage system comprised of light emitting diodes connection in series with various types of limit voltage circuit of the present invention. FIG. 9 shows a preferred embodiment of a light emitting variable resistance linear limit voltage system comprised of light emitting diodes connection in parallel with various types of limit voltage circuit of the present invention. FIG. 10 shows a preferred embodiment of a light emitting variable resistance linear limit voltage system comprised of light emitting diodes connection in series-parallel with various types of limit voltage circuit of the present invention. One or multiple unit of (dis) chargeable cell ESD100 is provided as may be required respectively at where dotted line indicates in those preferred embodiments illustrated in FIGS. 8, 9 and 10. The light emitting variable resistance linear limit voltage circuit system is formed by taking advantage of drop resistance and light emitting features of the light emitting diode LED 100, or furthermore, the positive drop feature or the limit voltage feature from the positive drop feature of the diode CR100 or the positive or reverse zener voltage of the zener diode ZD 100, or the impedance feature of the impedance device connected in series, parallel or series-parallel with the light emitting diode LED100.

The ESD100 relates to a Pb, NiH, NiZn, NiCd, NiFe, Li cell comprised of one or multiple cells connected in series, or to other types of rechargeable secondary cell, capacitor or super capacity. The ESD100 matches the light emitting variable resistance linear limit voltage circuit system, LRLV100, in the following manners:

(1) The light emitting variable resistance linear limit voltage circuit system LRLV100 comprised of one or multiple light emitting diodes LED100 connected in series, parallel or series-parallel is connected in parallel of the same polarity between the positive and negative polarities of a (dis)chargeable cell unit ESD100, and said light emitting diode LED100 may be connected to both terminals of the (dis)chargeable cell unit ESD100 in series or parallel depending on the selected polarity relation and on the polarity of a voltage drop created when the light emitting variable resistance linear limit voltage system LRLV100 passes through a branch current; or

(2) Said (dis)chargeable cell unit ESD100 is directly connected or via a switch or plug-socket unit or a terminal to the light emitting variable resistance linear limit voltage system LRLV100 either in series or parallel depending on the selected polarity relation.

(3) FIG. 11 shows a preferred embodiment of the present invention connected in series with a separation diode.

Within, the separation diode CR200 (or other device providing unidirectional conduction) is connected in series along the output direction as desired between the light emitting variable resistance linear limit voltage circuit system LRLV100 and the (dis)chargeable cell unit connected to it in parallel to prevent discharging in reverse direction. Depending on the application, the separation diode may be connected in series to a drop impedance device, or another limit voltage circuit LV101 of any type (or the light emitting variable resistance linear limit voltage system LRLV100) may be further connected in parallel at the output of the separation diode CR200 before reaching the (dis)chargeable cell unit ESD100.

An input at the light emitting variable resistance linear limit voltage circuit system LRLV100 connected in parallel with the (dis)chargeable cell unit as illustrated in FIG. 4 and FIG. 11 allows matched connection to various types of charging circuit system. As a result, after saturated charging, the charging circuit can be either cut off by manual. Detection may be provided to the terminal voltage of the cell in the course of charging or to the temperature rising effect when the charging is saturated. A negative voltage effect detected at the cell when the charging is saturated may serve reference for manipulation or circuit break at the time of saturated charging. Furthermore, a timer device may be used to control or cut off the charging to the cell or the charging process to the cell may be controlled by other methods of controlling the charging voltage and amperage.

Multiple units of output circuit can be formed based on the light emitting variable resistance linear limit voltage system LRLV100 by connecting multiple LRLV100 systems of the same polarity in series. FIG. 12 shows a schematic view of a circuit comprised of multiple units of (dis) chargeable cell connected in series matched by multiple sets of the light emitting variable resistance linear limit voltage circuit system also connected in series. Said circuit is essentially comprised of:

a light emitting variable resistance linear limit voltage system LRLV100: two or more than two systems of LRLV100 having the same polarity each comprised of one light emitting diode LED100, or multiple light emitting diodes LED100 connected in series, parallel or series-parallel are connect in series; or a limit voltage circuit LV101 of various types may be comprised of one or multiple types of at least one diode CR100, at least one positive or reverse zener effect device ZD100 containing a zener diode, or at least one impedance device Z0, or any combination of two or more than two of those devices connected in series. By utilizing the positive drop feature of the diode CR100 or the limit voltage feature of the zener voltage, and the drop resistance and light emitting features of the light emitting diode LED100 connected in series, the circuit of multiple units of light emitting variable resistance linear limit voltage circuit system LV101 is formed by connecting in series, parallel or series-parallel to one light emitting diode LED100 or multiple light emitting diodes LED100 connected in series, parallel or series-parallel. Or, said circuit of multiple units of LV101 may be comprised of at least one light emitting variable resistance linear limit voltage system LRLV100 connected in series to various types of limit voltage circuit unit LV101 of the same polarity. And, depending on the application requirements, multiple connection switches are optionally provided to respectively connect to both terminals of the (dis)chargeable cell unit ESD100 with the same polarity according to the drop polarity of the branch current passing through the switch.

a (dis)chargeable cell unit ESD100: includes a Pb, NiH, NiZn, NiCd, NiFe, Li cell comprised of one cell or multiple cells connected in series, or any other type of rechargeable secondary cell, capacitor or super capacity. The ESD100 matches the light emitting variable resistance linear limit voltage circuit system, LRLV100, in the following manners:

(1) The light emitting variable resistance linear limit voltage circuit system LRLV100 is connected in parallel of the same polarity between the positive and negative polarities of each (dis)chargeable cell unit ESD100, or

(2) Depending on the selected polarity relation, each pole of each of those (dis)chargeable cell units ESD100 indicating positive polarity connection in series are connected in parallel with each unit of those light emitting variable resistance linear limit voltage circuit systems LRLV100 respectively having series connectors in the form of direct connection, a switch, a plug-socket unit, or a connection terminal.

Each individual output of those units of light emitting variable resistance linear limit voltage circuit system connected in series of same polarity permits individual output for matched connection to the (dis) chargeable cell unit ESD100 to simultaneously or individually charge the (dis)chargeable cell unit ESD100. Furthermore, the light emitting variable resistance linear limit voltage circuit system LRLV100 may be connected in series of same polarity to various types of limit voltage circuit LV101 comprised of the diode CR100, positive or reverse zener diode ZD100 or the limit impedance device Z0 or any combination of those devices connected in series, parallel or series-parallel with its charging output including the following status:

(1) Depending on the selected polarity relation, each unit of light emitting variable resistance linear limit voltage circuit system LRLV100 and the output of each type of limit voltage circuit are simultaneously connected in parallel to each (dis)chargeable cell unit ESD100.

(2) As illustrated in FIG. 13, the preferred embodiment of the application of the light emitting variable resistance linear limit voltage circuit of the present invention connected in series with a combination of various types of limit voltage circuit, is comprised of certain units of the light emitting variable resistance linear limit voltage circuit system LRLV100 connected in parallel with the (dis)chargeable cells ESD100. Alternatively, depending on the application requirements, additional various types of limit voltage circuit LV101 are provided and jointly connected in parallel to the (dis)chargeable cells ESD100 to provide branch voltage with the remaining units of the light emitting variable resistance that are connected in series with said light emitting variable resistance linear limit voltage circuit system ESD100 but not connected in parallel with said (dis)chargeable cells to provide branch voltage. Furthermore, as may be required by other applications, separation diode CR200 (or other devices providing unidirectional conduction function) may be provided in series at the output to prevent reverse discharging as illustrated in FIG. 11. Said separation diode may be connected in series with drop impedance device, or the light emitting variable resistance linear limit voltage system LRLV100, or any type of limit voltage circuit LV101 may be connected in parallel at the loading terminal;

(3) FIG. 14 shows another preferred embodiment of having a light emitting variable resistance linear limit voltage circuit system of the present invention connected in series to a combined limit voltage circuit. Within, a portion of certain units of the light emitting variable resistance linear limit voltage system LRLV100 are connected in parallel to a (dis)chargeable cell unit ESD100 while certain units of another portion of light emitting variable resistance linear limit voltage system LRLV100 or various types of limit voltage circuit LV101 are connected in series to provide branch voltage function with those units of light emitting variable resistance linear limit voltage system LRLV100 connected in parallel with said (dis)chargeable cell ESD100. Or such branch voltage function may be provided by having the light emitting variable resistance linear limit voltage system LRLV100 connected in parallel (or in series, or series-parallel) to various types of limit voltage circuit LV101, then further connected in series to those units of light emitting variable resistance linear limit voltage system LRLV100 connected in parallel with said (dis)chargeable cell ESD100. Furthermore, as may be required by other applications, separation diode CR200 (or other devices providing unidirectional conduction function) may be provided in series at the output to prevent reverse discharging as illustrated in FIG. 11. Said separation diode may be connected in series with drop impedance device, or the light emitting variable resistance linear limit voltage system LRLV100, or any type of limit voltage circuit LV101 may be connected in parallel at the loading terminal

(4) FIG. 15 shows a preferred embodiment of the present invention connected in series at each output to a separation diode. Within, the separation diode CR200 to prevent reverse discharging is connected along the output direction as applicable between each unit of light emitting variable resistance limit voltage system LRLV100 and the (dis) chargeable cell connected in parallel with each unit of light emitting variable resistance limit voltage system LRLV100. Alternatively, another unit of various types of limit voltage circuit LV101 (or the light emitting variable resistance linear limit voltage circuit system LRLV100) is connected in parallel at the output of the separation diode CR200 already separated before reaching the (dis)chargeable cell ESD100.

The input of said unit of light emitting variable resistance linear limit voltage circuit system LRLV100 connected in parallel with the (dis)chargeable cell ESD100 as illustrated in FIGS. 4, and 11˜15 permits matched connection to various types of charging circuit system to charge the (dis)chargeable cell. As a result, after saturated charging, the charging circuit can be either cut off by manual. Detection may be provided to the terminal voltage of the cell in the course of charging or to the temperature rising effect when the charging is saturated. A negative voltage effect detected at the cell when the charging is saturated may serve reference for manipulation or circuit break at the time of saturated charging. Furthermore, a timer device may be used to control or cut off the charging to the cell or the charging process to the cell may be controlled by other methods of controlling the charging voltage and amperage.

Furthermore, depending on circuit requirements, said light emitting variable resistance linear limit voltage system LRLV100 or any type of the limit voltage circuit LV101 as illustrated in FIGS. 4, and 11˜15 may be selected from the following devices:

a light emitting diode LED100, comprised of one light emitting diode or of multiple light emitting diodes connected in series-parallel to provide functions of bias and light emitting variable resistance, and function of simultaneous light emitting display if required;

an impedance device Z0: as required, an alternative resistance impedance or an inductive or capacity impedance or a combination of any two or more than two types of resistance, inductive and/or capacity impedance may be used in case that a DC source for input contains DC impulse source of ripple; within, the resistance impedance includes a general resistance, or a positive temperature coefficient (PTC) resistance or a negative temperature coefficient (NTC) resistance along, or is comprised of two or more than two impedance connected in series, parallel or series-parallel;

a diode CR100 includes a diode CR100 comprised of various materials and structures, and other solid state electronic device capable of creating an equivalent to a positive drop effect of the diode CR100 when current passes through said device, a zener diode ZD100 in its positive or negative direction, or a solid state electronic device equivalent to zener effect of the zener diode ZD100;

a separation diode CR200 includes the separation diode CR200 comprised of various materials and structures and other solid state electronic devices such as a light emitting diode or a zener diode that is equivalent to the rated voltage range and unidirectional separation effect of the separation diode CR200.

To sum up, the light emitting variable resistance linear limit voltage system LRLV100 disclosed in the present invention for being able to ensure fully saturated charging by the (dis)chargeable cell ESD100, prevent said (dis) chargeable cell ESD100 from being damaged by overcharging, reduce thermal loss for the limit voltage circuit and provide light emitting display as required, is innovative, allows lower production cost of the circuit configuration, and gives precise functions. Therefore, an application for patent is filed accordingly.

1. A light emitting variable resistance linear limit voltage circuit system comprised to replace a zener diode or a diode or an impedance device or to combine any of said device by taking advantage of drop and impedance features by one light emitting diode or multiple light emitting diodes connected in series, parallel or series-parallel capable of transferring electric energy into thermal energy and optical energy so to reduce heat generation without compromising its linear limit voltage feature, and to provide display function as required; in addition to applying in various circuits, said light emitting variable resistance linear limit voltage system functions to protect charging process depending on the polarity of the drop passing through the light emitting variable resistance linear limit voltage circuit system LRLV100 by connecting in series, or parallel to both terminals of a (dis)chargeable cell ESD100 according to the polarity relation selected, or by connecting in series or parallel to a electromechanical or solid state switching system or to a linear control device CU100, and connecting to load in series or parallel to be subject to manipulation, essentially comprised of
a light emitting variable resistance linear limit voltage system LRLV100 comprised of one or multiple light emitting diodes LED100 connected either in series, parallel or series-parallel; or of at least one type or multiple types of one or multiple diodes CR100, positive or reverse zener diode ZD100 or other zener effect device, and/or impedance device Z0 connected in series, parallel or series-parallel; then the LV101 is connected in series, parallel, or series-parallel with one or multiple light emitting diodes LED100 connected in series, parallel or series-parallel to combine the LRLV100 to take advantage of drop resistance and light emitting features of the light emitting diode LED 100, or furthermore, the positive drop feature or the limit voltage feature of the diode CR100, or the positive or reverse zener voltage of the zener diode ZD100, or the impedance feature of the impedance device Z0 connected in series, parallel or series-parallel with the light emitting diode LED100 to form the light emitting variable resistance linear limit voltage circuit system.

2. A light emitting variable resistance linear limit voltage circuit system as claimed in claim 1, within, said light emitting variable resistance linear limit voltage system LRLV100 contains one light emitting diode or multiple light emitting diodes LED100 connected in series, parallel, or series-parallel, and is connected in series or parallel to a (dis) chargeable cell ESD100 depending on the polarity relation selected.

3. A light emitting variable resistance linear limit voltage circuit system as claimed in claim 1, within, said light emitting variable resistance linear limit voltage system LRLV100 comprised of one light emitting diode or multiple light emitting diodes LED100 connected in series, parallel or series-parallel is connected in series or parallel to an electromechanical or a solid state switching system or a linear control system CU100, and is further connected in series or parallel to a load for manipulation.

4. A light emitting variable resistance linear limit voltage circuit system as claimed in claim 1, within, said light emitting variable resistance linear limit voltage circuit system LRLV100 contains at least one diode CR100, or at least one positive or reverse zener diode ZD100 or other zener effect device, or at least one impedance device ZO wherein one type of multiple types of one or multiple devices are connected in series, parallel or series-parallel to form various types of limit voltage circuit LV101; said LV101 then is connected in series, parallel or series-parallel to one or multiple light emitting diodes LED100 connected in series, parallel or series-parallel to form in combination the light emitting variable resistance linear limit voltage circuit system LRLV100.

5. A light emitting variable resistance linear limit voltage circuit system as claimed in claim 1, within, said light emitting variable resistance linear limit voltage system LRLV100 contains at least one diode CR100, or at least one positive or reverse zener diode ZD100 or other zener effect device, or at least one impedance device Z0 wherein one type of multiple types of one or multiple devices are connected in series, parallel or series-parallel to form various types of limit voltage circuit LV101; said LV101 then is connected in series, parallel or series-parallel to one or multiple light emitting diodes LED100 connected in series, parallel or series-parallel to form in combination the light emitting variable resistance linear limit voltage circuit system LRLV100; and depending on the drop polarity of said light emitting variable resistance linear limit voltage circuit system LRLV100 passing through a branch current, said light emitting variable resistance linear limit voltage circuit system LRLV100 is connected in parallel of the same polarity to both terminals of a (dis)chargeable cell ESD100 to serve as a protection over charging process.

6. A light emitting variable resistance linear limit voltage circuit system as claimed in claim 1, within, said light emitting variable resistance linear limit voltage system LRLV100 contains at least one diode CR100, or at least one positive or reverse zener diode ZD100 or other zener effect device, or at least one impedance device Z0 wherein one type of multiple types of one or multiple devices are connected in series, parallel or series-parallel to form various types of limit voltage circuit LV101; said LV101 then is connected in series, parallel or series-parallel to one or multiple light emitting diodes LED100 connected in series, parallel or series-parallel to form in combination the light emitting variable resistance linear limit voltage circuit system LRLV100; and depending on the drop polarity of said light emitting variable resistance linear limit voltage circuit system LRLV100 passing through a branch current, said light emitting variable resistance linear limit voltage circuit system LRLV100 is connected in series or parallel with an electromechanical or a solid state switching system or a linear control system CU100 and connected in series to a load for manipulation according to the polarity relation selected.

7. A light emitting variable resistance linear limit voltage circuit system as claimed in claim 1, within, said (dis) chargeable cell ESD100 is comprised of a Pb, NiH, NiZn, NiCd, NiFe, Li cell comprised of one cell or multiple cells connected in series, or any other type of rechargeable secondary cell, capacitor or super capacity.

8. A light emitting variable resistance linear limit voltage circuit system as claimed in claim 1, within, said (dis)chargeable cell ESD100 matches the light emitting variable resistance linear limit voltage circuit system, LRLV100, in a way such that the light emitting variable resistance linear limit voltage circuit system LRLV100 comprised of one or multiple light emitting diodes LED100 connected in series, parallel or series-parallel is connected in parallel of the same polarity between the positive and negative polarities of a (dis)chargeable cell unit ESD100, and said light emitting diode LED100 may be connected to both terminals of the (dis)chargeable cell unit ESD100 in series or parallel depending on the selected polarity relation and on the polarity of a voltage drop created when the light emitting variable resistance linear limit voltage system LRLV100 passes through a branch current.

9. A light emitting variable resistance linear limit voltage circuit system as claimed in claim 1, within said (dis)chargeable cell ESD100 matches the light emitting variable resistance linear limit voltage circuit system, LRLV100, in a way such that said (dis) chargeable cell unit ESD100 is directly connected or via a switch or plug-socket unit or a terminal to the light emitting variable resistance linear limit voltage system LRLV100 either in series or parallel depending on the selected polarity relation.

10. A light emitting variable resistance linear limit voltage circuit system as claimed in claim 1, within, said (dis)chargeable cell ESD100 matches the light emitting variable resistance linear limit voltage circuit system, LRLV100, in a way such that a separation diode CR200 (or other device providing unidirectional conduction) is connected in series along the output direction as desired between the light emitting variable resistance linear limit voltage circuit system LRLV100 and the (dis)chargeable cell unit connected to it in parallel to prevent discharging in reverse direction.

11. A light emitting variable resistance linear limit voltage circuit system as claimed in claim 10, within, the separation diode may be connected in series to a drop impedance device, or another limit voltage circuit LV101 of any type (or the light emitting variable resistance linear limit voltage system LRLV100) may be further connected in parallel at the output of the separation diode CR200 before reaching the (dis)chargeable cell unit ESD100.

12. A light emitting variable resistance linear limit voltage circuit system as claimed in claims 1, 10, or 11, within, an input at the light emitting variable resistance linear limit voltage circuit system LRLV100 connected in parallel with the (dis)chargeable cell unit allows matched connection to various types of charging circuit system; after saturated charging, the charging circuit can be either cut off by manual and a detection may be provided to the terminal voltage of the cell in the course of charging or to the temperature rising effect when the charging is saturated, or a negative voltage effect detected at the cell when the charging is saturated may serve reference for manipulation or circuit break at the time of saturated charging; or a timer device may be used to control or cut off the charging to the cell or the charging process to the cell may be controlled by other methods of controlling the charging voltage and amperage.

13. A light emitting variable resistance linear limit voltage circuit system as claimed in claim 1, within, said light emitting variable resistance linear limit voltage system LRLV100 is in the form of multiple units of output circuit comprised of multiple units of light emitting variable resistance linear limit voltage circuit connected of same polarity in series, and is essentially comprised of
a light emitting variable resistance linear limit voltage system LRLV100, within, two or more than two systems of LRLV100 having the same polarity each comprised of one light emitting diode LED100, or multiple light emitting diodes LED100 connected in series, parallel or series-parallel are connect in series; or a limit voltage circuit LV101 of various types may be comprised of one or multiple types of at least one diode CR100, at least one positive or reverse zener effect device ZD100 containing a zener diode, or at least one impedance device Z0, or any combination of two or more than two of those devices connected in series; then by utilizing the positive drop feature of the diode CR100 or the limit voltage feature of the zener voltage, and the drop resistance and light emitting features of the light emitting diode LED100 connected in series, the circuit of multiple units of light emitting variable resistance linear limit voltage circuit system LV101 is formed by connecting in series, parallel or series-parallel to one light emitting diode LED100 or multiple light emitting diodes LED100 connected in series, parallel or series-parallel; or said circuit of multiple units of LV101 may be comprised of at least one light emitting variable resistance linear limit voltage system LRLV100 connected in series to various types of limit voltage circuit unit LV101 of the same polarity; and, depending on the application requirements, multiple connection switches are optionally provided to respectively connect to both terminals of the (dis)chargeable cell unit ESD100 with the same polarity according to the drop polarity of the branch current passing through the connection plug.

14. A light emitting variable resistance linear limit voltage circuit system as claimed in claim 1, within, Pb, NiH, NiZn, NiCd, NiFe, Li cell comprised of one cell or multiple cells connected in series, or any other type of rechargeable secondary cell, capacitor or super capacity and the ESD100 matches the light emitting variable resistance linear limit voltage circuit system, LRLV100 in such way that the light emitting variable resistance linear limit voltage circuit system LRLV100 is connected in parallel of the same polarity between the positive and negative polarities of each (dis)chargeable cell unit ESD100.

15. A light emitting variable resistance linear limit voltage circuit system as claimed in claim 1, within, depending on the selected polarity relation, multiple units of (dis)chargeable cell units ESD100 match the light emitting various resistance linear limit voltage circuit system in a way such that each pole of said (dis)chargeable cell units ESD100 indicating positive polarity connection in series are connected in parallel with those light emitting variable resistance linear limit voltage circuit systems LRLV100 also indicating positive polarity connection in series respectively having series connectors respectively in the form of a direct connection, a switch, a plug-socket unit, or a connection terminal.

16. A light emitting variable resistance linear limit voltage circuit system as claimed in claim 15, within, each individual output of those units of light emitting variable resistance linear limit voltage circuit system connected in series of same polarity permits individual output for matched connection to the (dis) chargeable cell unit ESD100 to simultaneously or individually charge the (dis)chargeable cell unit ESD100; furthermore, the light emitting variable resistance linear limit voltage circuit system LRLV100 may be connected in series of same polarity to various types of limit voltage circuit LV101 comprised of the diode CR100, positive or reverse zener diode ZD100 or the limit impedance device ZO or any combination of those devices connected in series, parallel or series-parallel with its charging output including the status that depending on the selected polarity relation, each unit of light emitting variable resistance linear limit voltage circuit system LRLV100 and the output of each type of limit voltage circuit are simultaneously connected in parallel to each (dis)chargeable cell unit ESD100.

17. A light emitting variable resistance linear limit voltage circuit system as claimed in claim 15, within, a charging application includes that combines the light emitting variable resistance linear limit voltage circuit and various types of limit voltage circuit connected in series; and is essentially comprised of certain units of the light emitting variable resistance linear limit voltage circuit system LRLV100 connected in parallel with the (dis)chargeable cells ESD100, Alternatively, depending on the application requirements, additional various types of limit voltage circuit LV101 are provided and jointly connected in parallel to the (dis) chargeable cells ESD100 to provide branch voltage with the remaining units of the light emitting variable resistance that are connected in series with said light emitting variable resistance linear limit voltage circuit system ESD100 but not connected in parallel with said (dis)chargeable cells to provide branch voltage.

18. A light emitting variable resistance linear limit voltage circuit system as claimed in claim 17, within, depending on the charging application desires, a separation diode CR200 (or other devices providing unidirectional conduction function) may be provided in series at the output to prevent reverse discharging; and said separation diode may be connected in series with drop impedance device, or the light emitting variable resistance linear limit voltage system LRLV100, or any type of limit voltage circuit LV101 may be connected in parallel at the loading terminal.

19. A light emitting variable resistance linear limit voltage circuit system as claimed in claim 15, within, its charging application includes the combination of the light emitting variable resistance linear limit voltage circuit and various types of limit voltage circuit connected in series, and is comprised of a portion of the light emitting variable resistance linear limit voltage system LRLV100 connected in parallel to a (dis)chargeable cell unit ESD100 while the other portion of light emitting variable resistance linear limit voltage system LRLV100 or various types of limit voltage circuit LV101 are connected in series to provide branch voltage function with those units of light emitting variable resistance linear limit voltage system LRLV100 connected in parallel to said (dis)chargeable cell ESD100. Or such branch voltage function may be provided by having the light emitting variable resistance linear limit voltage system LRLV100 connected in parallel (or in series, or series-parallel) to various types of limit voltage circuit LV101, then further connected in series to those units of light emitting variable resistance linear limit voltage system LRLV100 connected in parallel with said (dis)chargeable cell ESD100.

20. A light emitting variable resistance linear limit voltage circuit system as claimed in claim 19, within, as required, its charging application includes an option of having a separation diode CR200 (or other devices providing unidirectional conduction function) may be provided in series at the output to prevent reverse discharging and said separation diode may be connected in series with drop impedance device, or the light emitting variable resistance linear limit voltage system LRLV100, or any type of limit voltage circuit LV101 may be connected in parallel at the loading terminal.

21. A light emitting variable resistance linear limit voltage circuit system as claimed in claim 15, within, depending on the application requirements, its charging application may include a separation diode CR200 connected in series along the direction of output between each unit of light emitting variable resistance linear limit voltage system and the (dis)chargeable cell unit connected in parallel to prevent reverse discharging; or having another unit of various types of limit voltage circuit LV101 (or a light emitting variable resistance linear limit voltage circuit system LRLV100 further connected in parallel at the output terminal of the diode CR200 already separated before reaching the (dis) chargeable cell ESD100.

22. A light emitting variable resistance linear limit voltage circuit system as claimed in claims 1, 2, 3, 4, 5, 6, 7, 8, 9, 10, 11, 12, 13, 14, 15, 16, 17, 18, 19, 20 or 21, within, the input of the light emitting variable resistance linear limit voltage circuit system LRLV100 connected in parallel with the (dis)chargeable cell ESD100 permits matched connection to various types of charging circuits so that after saturated charging, the charging circuit can be either cut off by manual; and detection may be provided to the terminal voltage of the cell in the course of charging or to the temperature rising effect when the charging is saturated; or a negative voltage effect detected at the cell when the charging is saturated may serve reference for manipulation or circuit break at the time of saturated charging; a timer device may be used to control or cut off the charging to the cell or the charging process to the cell may be controlled by other methods of controlling the charging voltage and amperage.

23. A light emitting variable resistance linear limit voltage circuit system as claimed in claims 1, 2, 3, 4, 5, 6, 7, 8, 9, 10, 11, 12, 13, 14, 15, 16, 17, 18, 19, 20 or 21, within, said light emitting variable resistance linear limit voltage circuit systemLRLV100 or any type of limit voltage circuit LV101 may be selected as applicable from devices comprised of
a light emitting diode LED100, comprised of one light emitting diode or of multiple light emitting diodes connected in series-parallel to provide functions of bias and light emitting variable resistance, and function of simultaneous light emitting display if required;
an impedance device Z0: as required, an alternative resistance impedance or an inductive or capacity impedance or a combination of any two or more than two types of resistance, inductive and/or capacity impedance may be used in case that a DC source for input contains DC impulse source of ripple; within, the resistance impedance includes a general resistance, or a positive temperature coefficient (PTC) resistance or a negative temperature coefficient (NTC) resistance along, or is comprised of two or more than two impedance connected in series, parallel or series-parallel;
a diode CR100 includes a diode CR100 comprised of various materials and structures, and other solid state electronic device capable of creating an equivalent to a positive drop effect of the diode CR100 when current passes through said device, a zener diode ZD100 in its positive or negative direction, or a solid state electronic device equivalent to zener effect of the zener diode ZD100; and
a separation diode CR200 includes the separation diode CR200 comprised of various materials and structures and other solid state electronic devices such as a light emitting diode or a zener diode that is equivalent to the rated voltage range and unidirectional separation effect of the separation diode CR200.
